(19) United States
(12) Patent Application Publication
(10) Pub. No.: US 2008/0235051 A1
(43) Pub. Date: Sep. 25, 2008

(54) Internet-based system for curing alcoholism and other human problem conditions, and for assuring continued participation by clients to assure commercial viability

(76) Inventor: Doug Krotzer, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/077,361

(22) Filed: Mar. 19, 2008

Related U.S. Application Data
(60) Provisional application No. 60/918,776, filed on Mar. 19, 2007.

(51) Int. Cl. G06Q 50/00; G06Q 20/00

(52) U.S. Cl. 705/2

(57) ABSTRACT

An Internet methodology for the treatment of human problem conditions such as alcoholism, obesity/weight loss, depression or the like, or for long-term commercial enterprise, wherein capturing the client during a short window of opportunity and providing means to assure continued participation in the treatment program is essential, both for the success of the treatment and for providing a viable commercial enterprise. The methodology comprises control of website design, advertising, sale closing, pricing, guaranteed payment, monitoring and quality control of nutraceuticals.

This application claims the benefit of United States Provisional Patent Application Ser. No. 60/918,776, filed Mar. 19, 2007.

### BACKGROUND OF THE INVENTION

This invention relates generally to the field of Internet-based systems for the treatment of human problem conditions such as alcoholism, obesity/weight loss, depression or the like, wherein capturing the client during a short window of opportunity and providing means to assure continued participation in the treatment program is essential, both for the success of the treatment and for providing a viable commercial enterprise.

Two well-known problems occur in all attempts to treat alcoholism. The first is that there is a limited window of opportunity in which the alcoholic is inclined to seek treatment. For the vast majority of an alcoholic's awake hours, the alcoholic is either inebriated or in denial as to the existence of a problem. The second problem is assuring that when a treatment program begins, the client continues participation throughout the program as long as necessary. Forced treatment programs, such as interventions or court-ordered rehab, are usually not successful because the individual has not made a conscious choice to participate. Voluntary programs also have low success rates because it is too easy for the individual to quit and no ramifications if he does. Likewise, there are no incentives for the individual to remain in treatment.

Addressing these issues also applies to other commercial enterprises as well, where capturing and keeping a client or customer, as well as insuring a continuing revenue stream, is critical for the success of both the treatment and the continued viability of the commercial enterprise. Use of the Internet and specific techniques addressed herein has proven to satisfactorily solve these diverse problems.

### SUMMARY OF THE INVENTION

The invention is an Internet methodology for the treatment of human problem conditions such as alcoholism, obesity/weight loss, depression or the like, wherein capturing the client during a short window of opportunity and providing means to assure continued participation in the treatment program is essential, both for the success of the treatment and for providing a viable commercial enterprise. Likewise, the method applies to long-term commercial enterprise business relationships where goods or services are provided. The methodology in various embodiments comprises all or some of the following: control of website design, advertising, sale closing, pricing, guaranteed payment, monitoring and quality control of nutraceuticals.

The methodology requires the presence of an Internet website having particular structures and features, including text pages having a length that exceeds the screen size so that scrolling is required, an extensive table of contents and express jump buttons always visible on any page. Advertising of the program during particular hours is important. Instant sign-up via credit card is essential, followed by personal contact with the new client as soon as possible after sign-up. There is a particular pricing structure that comprises a low initial outlay with the on-going fees characterized in daily dollar values such that it is easy to relate the cost to money saved by not drinking. Long-term contracts are required that include terms for automatic acceleration of all fees if a cancellation request is received. Continual monitoring and feed-back over the Internet is provided during the treatment period, as is on-going availability of support after cure. Sourcing and supply of quality nutraceuticals is essential.

In one embodiment, the method comprises capturing and retaining individuals in a voluntary treatment program comprising the steps of:

providing an Internet website comprising large amounts of information, wherein the information is presented under different headings with multiple pages of text, the text extending beyond a single visible screen such that scrolling is required to continue reading the text, a continuously visible table of contents on each page, wherein the table of contents remains visible as the individual scrolls down the text page, and prominent linking icons positioned on the text pages;

providing advertising to the individuals during hours when the individuals are most likely to be receptive to such advertising;

providing a means to join the voluntary treatment program immediately online through acceptance of credit cards as payment;

providing an on-line assessment form to be filled out by the individual and contacting the individual within one day of filling out the assessment form;

providing a pricing structure for the treatment program with a low initial cost and remaining costs disclosed as daily expenses; and

providing a long-term contract that is executed by the individual, wherein the individual agrees to acceleration of all charges in the event of a cancellation request by the individual.

In another embodiment, the method comprises capturing and retaining individuals in a voluntary alcoholic treatment program comprising the steps of:

providing an Internet website comprising large amounts of information on alcoholism, wherein the information is presented under different headings with multiple pages of text, the text extending beyond a single visible screen such that scrolling is required to continue reading the text, a continuously visible table of contents on each page, wherein the table of contents remains visible as the individual scrolls down the text page, and prominent linking icons positioned on the text pages;

providing advertising to the individuals during the hours between 10 AM and 3 PM when the individuals are most likely to be receptive to such advertising;

providing a means to join the voluntary treatment program immediately online through acceptance of credit cards as payment;

providing an on-line assessment form to be filled out by the individual and contacting the individual within one day of filling out the assessment form;

providing a pricing structure for the treatment program with a low initial cost and remaining costs disclosed as daily expenses;

providing a long-term contract that is executed by the individual, wherein the individual agrees to acceleration of all charges in the event of a cancellation request by the individual;

determining a treatment program of nutraceuticals and providing sourcing and supply of quality nutraceuticals; and

providing on-going monitoring of the individual's progress in the program.

In another embodiment, the method comprises capturing and retaining individuals in a long-term commercial business relationship providing services or goods to the individual in return for payments under a long-term contract using the Internet as the primary communication medium comprising the steps of:

providing an Internet website comprising large amounts of information;

providing a means to purchase the services or goods immediately online through acceptance of credit cards as payment;

providing a pricing structure with a low initial cost; and

providing a long-term contract that is executed by the individual, wherein the individual agrees to acceleration of all charges in the event of a cancellation request by the individual.

### DETAILED DESCRIPTION OF THE INVENTION

While the invention is described herein with main reference to the treatment and cure of alcoholism, it is to be understood that the methodology is applicable in part or in whole to the treatment of other human problem conditions, such as obesity and depression, as well as to Internet commerce in general wherein capture and retention of clients or customers while providing extended payment plans is desirable. With regard to commercial enterprises consisting of the selling and providing of goods or services, the method steps relating to nutraceuticals and certain monitoring steps are not present.

In terms of the treatment and cure of alcoholism, molecule multiplicity (i.e., the use of combinations of molecules that together produce efficacious results) is necessary to reproduce the good feelings of alcohol. If this were not so, alcohol would not have reigned alone as the pleasure giving substance of choice for millennium. That is why pharmaceuticals (one molecule by definition) will probably never work. Nutraceuticals (organically or naturally supplied elements, as opposed to synthetic elements) in many cases work better that any other molecules derived from or like them, which is the common way to produce pharmaceuticals. Synergistic combinations of nutraceuticals that have some effect overcome each one's lack of ability to cure many on its own. Upon properly assessing and analyzing feedback from the individual seeking treatment in response to interviews or questionnaires, a proper combination and regimen of nutraceuticals is provided.

One major component of the invention involves the design of the website, and it has been discovered that some conventional wisdom in the industry is wrong. In the circumstances at hand, for example, it is clear that less is not more—that is, rather than attempting to present information in a short and concise manner that fits easily within the view screen, it is necessary in the treatment program, and with application to scientific sites in general, to utilize large amounts of text that are presented under multiple headings with long pages that extend beyond a single screen display so as to require interaction by the reader in the form of scrolling.

A long table of contents with a continual presence along the left hand margin of each page no matter how far down in the text the visitor has scrolled impresses visitors with the massive size of the site, showing that the reason for the long pages is the huge amount of useful information that is available. Most importantly, the long and continuously visible table of contents solves the problem of visitor loss of interest in the text on one long page, as the table of contents is immediately available to take the reader somewhere else in the site.

Another necessity in the website design is the use of large linking icons, designated as Express buttons, to avoid flagging interest and bouncing around the website. About 60%-95% of viewers exit at each page, so using large, text breaking buttons to pique interest and overcome boredom is essential. The buttons immediately transport readers to a high interest area. Use of whimsical text on buttons, similar to “Follow Me” or the like, is useful to initiate action. It is also useful to provide for “mouse-over” action on the buttons, such as where the buttons move and appear 3-D when the cursor is rolled across. Such large buttons are more effective than in-text links, bold text, highlights and colors. In addition to buttons, the use of bullets and numbering is important to engender continued attention by the reader.

Another component in the system is proper advertising. Dominance on the Internet in terms of search result preferences is very important. As for treating alcoholics, there are limited windows of opportunity during which an alcoholic is likely to seek help on the Internet. The site needs to be viewed within one week of an “alcohol scare”, such as an arrest for DUI or other alcohol offenses, a spouse leaving, the loss of a job or a doctor diagnosis of severe alcohol-related medical problems. Advertising on other internet sites, television, radio and the like during the hours of 10 AM to 3 PM is important, as this block of time is when most alcoholics will be most coherent and alert, such as the time they are at work. These hours are typically, except for the lunch hour, less likely to be social hours where having a drink will be encouraged by third parties. The program appeals to the goal of every alcoholic—the opportunity to continue social drinking, as other programs prohibit social drinking.

As with many business transactions, closing the sale is essential to success. The client should find it very easy to sign up by credit card, with ample linking via the many Express buttons to the sign-up page. For potential clients that fill out an assessment on-line, or for when a third party (wife, parent, etc.) fills out the assessment for another, contact by trained personnel by telephone within 15 to 30 minutes of input is needed. If they cannot be reached by phone, then contact by e-mail is initiated as soon as possible and no later than the following day.

Proper pricing for the treatment program insures that clients will sign up and then remain with the program. Since alcoholics deny a problem, they need to be eased into pricing by avoiding the significance of the expense, instead relating it to the amount of money to be saved when they stop drinking. In effect, the program will pay for itself from the savings. Keeping the initial outlay below $500 with the promise of a cure is low enough to avoid initial shock, along with featuring the disclosure that payments will not continue unless they are cured.

Pricing steps up during the first three months, with pricing quoted as a daily cost. In the low level program, the per day pricing will escalate from $2 to $3 to $6, while the more intensive program is $3.33 to $5 to $9 per day. If the client is not cured after following all the treatment steps, then payment obligations cease.

If the client is slow in reacting favorably to treatment, various mechanisms for offering partial refunds of amounts already paid can reassure clients they will be cured if they persist with the program.

It is essential for both the cure and for the viability of the business that the clients stay with the program. Attention Deficit is a common alcoholic symptom. In addition, once cured, the incentive to stay with the program is dramatically reduced. For this reason a long-term contract is essential, and an important component of the contract is a provision for acceleration of the total contract fees due in the event that the client requests cancellation. This is a critical incentive for the client to continue with the program, as it then becomes more costly for the client to drop the program as it is for the client to continue with it. The availability of ongoing monitoring, and availability for counseling, support and other long-term care methodologies to avoid recidivism and back-sliding, is important.

Monthly payments for expert monitoring are required, as keeping an on-line diary on the Internet that is monitored by trained staff is required during the pre-cure treatment period and is important for continued success. The on-line diary is a structured document that provides focused questions or topics that illicit answers over approximately five to seven day periods necessary for the monitors to adapt the treatment regimen, assess side effect problems and generally keep abreast of the progress of the client. After cure, clients will typically cease keeping the on-line diary, but because they are secured in the long-term program, they are aware that help and support is an instant on-line communication away—in other words, all of the benefits of the program remain available. Because the clients are still paying for this service, they are more inclined to make this contact should problems occur from their withdrawal from the active treatment regimen. Once contact has been re-established, the monitors can then guide the client back into the regimen. On-line publication of a newsletter at periodic intervals or other forms of e-mail contact also will keep the program in the mind of the clients.

A key technique is acceleration of credit card charges. When the client indicates a reluctance to continue to pay, the payments are accelerated by previous contractual agreement. The request for cancellation is the trigger for acceleration, not actual default in payments.

In the chargeback process, where a client disputes the ongoing charges with his or her credit card company, the credit card companies typically do not let merchants propose questions to cardholders they could not answer without admitting they authorized the charge and received the products or services for which they agreed to pay. Doing so would resolve most of these problems in a positive way, as the cardholders often offer very feeble excuses for not paying. The current system is a nightmare for everyone involved, dancing around laws to protect lying customers. A few direct and specific questions, possibly developed jointly with the credit card companies, that are particular to each merchant would be legal, and help all involved reach better solutions and justice for all at almost no additional cost. These questions often result in the client acknowledging that the contract was entered into through their Internet activity in joining and encourage getting back on the program that cured them before, making payment and feeling good about the credit card company that helped them keep their legal obligations without hassle, and to the benefit of their health.

A possible component of the method is having Judges sentence DUI offenders to a brain chemistry program. Currently, first offenders are sentenced to AA, second offenders to a 30-day detoxification clinic (forced sobriety), and third offenders to jail. None of these work much above the 35% willpower method. Only through Internet monitoring can such a program be administered economically and in mass numbers.

Delivering quality nutraceuticals (especially herbs) is impossible for all except a few major companies. For smaller companies that cannot buy bulk from certain sources, it is essential that the clients be given information. The methodology requires recommending only the top few companies that sell retail and with respect to certain ingredients, winnowing out those top quality companies that have inferior specifically needed products, as customers cannot tell quality on their own, even when they read the labels.

Trained monitors insure that the clients are buying from the proper sources, so that the clients get standardized, bio-available nutraceuticals. Side effects must be monitored, again requiring an on-going program of treatment and input by the clients provided over the Internet. Side effects can be especially caused by contamination, possibly from counterfeit products. By being part of the program, the results from hundreds of other clients are at hand, such that the monitors may discover a trend that would be unknown to doctors that only see one or two patients. Depression, anxiety, blood pressure, attention deficit, sleep disorder, cholesterol and triglycerides are monitored, among other symptoms common to alcoholics. For problem cases, references to other sources on the Internet are provided.

It is understood and contemplated that equivalents and substitutions to the elements and steps set forth above may be obvious to those skilled in the art, and therefore the true scope and definition of the invention is to be as set forth in the following claims.

I claim:

1. A method of capturing and retaining individuals in a voluntary treatment program comprising the steps of:
providing an Internet website comprising large amounts of information, wherein the information is presented under different headings with multiple pages of text, the text extending beyond a single visible screen such that scrolling is required to continue reading the text, a continuously visible table of contents on each page, wherein the table of contents remains visible as the individual scrolls down the text page, and prominent linking icons positioned on the text pages;
providing advertising to the individuals during hours when the individuals are most likely to be receptive to such advertising;
providing a means to join the voluntary treatment program immediately online through acceptance of credit cards as payment;
providing an on-line assessment form to be filled out by the individual and contacting the individual within one day of filling out the assessment form;
providing a pricing structure for the treatment program with a low initial cost and remaining costs disclosed as daily expenses; and
providing a long-term contract that is executed by the individual, wherein the individual agrees to acceleration of all charges in the event of a cancellation request by the individual.

2. The method of claim 1, further providing the step of providing sourcing and supply of quality nutraceuticals

3. The method of claim 1, further comprising the step of providing on-going monitoring of the individual's progress in the program.

4. The method of claim 2, further comprising the step of providing on-going monitoring of the individual's progress in the program.

5. The method of claim 1, further comprising the step of providing specific questions to be asked of individuals in charge-back situations, such that the credit card companies are less likely to allow the charge-back.

6. A method of capturing and retaining individuals in a voluntary alcoholic treatment program comprising the steps of:
providing an Internet website comprising large amounts of information on alcoholism, wherein the information is presented under different headings with multiple pages of text, the text extending beyond a single visible screen such that scrolling is required to continue reading the text, a continuously visible table of contents on each page, wherein the table of contents remains visible as the individual scrolls down the text page, and prominent linking icons positioned on the text pages;
providing advertising to the individuals during the hours between 10 AM and 3 PM when the individuals are most likely to be receptive to such advertising;
providing a means to join the voluntary treatment program immediately online through acceptance of credit cards as payment;
providing an on-line assessment form to be filled out by the individual and contacting the individual within one day of filling out the assessment form;
providing a pricing structure for the treatment program with a low initial cost and remaining costs disclosed as daily expenses;
providing a long-term contract that is executed by the individual, wherein the individual agrees to acceleration of all charges in the event of a cancellation request by the individual;
determining a treatment program of nutraceuticals and providing sourcing and supply of quality nutraceuticals; and
providing on-going monitoring of the individual's progress in the program.

7. The method of claim 6, further comprising the step of providing specific questions to be asked of individuals in charge-back situations, such that the credit card companies are less likely to allow the charge-back.

8. A method of capturing and retaining individuals in a long-term commercial business relationship providing services or goods to the individual in return for payments under a long-term contract using the Internet as the primary communication medium comprising the steps of:
providing an Internet website comprising large amounts of information;
providing a means to purchase the services or goods immediately online through acceptance of credit cards as payment;
providing a pricing structure with a low initial cost; and
providing a long-term contract that is executed by the individual, wherein the individual agrees to acceleration of all charges in the event of a cancellation request by the individual.

9. The method of claim 8, wherein the information is presented under different headings with multiple pages of text, the text extending beyond a single visible screen such that scrolling is required to continue reading the text, a continuously visible table of contents on each page, wherein the table of contents remains visible as the individual scrolls down the text page, and prominent linking icons positioned on the text pages.

10. The method of claim 8, further comprising the step of providing advertising to the individuals during hours when the individuals are most likely to be receptive to such advertising.

11. The method of claim 8, further comprising the step of providing specific questions to be asked of individuals in charge-back situations, such that the credit card companies are less likely to allow the charge-back.
